(19) United States
(12) Patent Application Publication
(10) Pub. No.: US 2010/0037528 A1
(43) Pub. Date: Feb. 18, 2010

(54) CARGO DOOR/RAMP LIFT ASSIST SYSTEM

(76) Inventor: Michael Lambright, Goshen, IN (US)

Correspondence Address: BUTZEL LONG;IP DOCKETING DEPT, 350 SOUTH MAIN STREET, SUITE 300, ANN ARBOR, MI, 48104, US

(21) Appl. No.: 12/249,002

(22) Filed: Oct. 10, 2008

Related U.S. Application Data
(60) Provisional application No. 60/981,047, filed on Oct. 18, 2007.

(51) Int. Cl. B60P 1/26; B62D 33/03; B60P 1/43; E05F 11/04

(52) U.S. Cl. 49/347; 296/61

(57) ABSTRACT

A lift assist system for cargo door ramps of trucks and trailers or other pivotal closures which includes a spring assembly containing a compressible spring element which is compressed when a cargo door is moved into an open position. As the compressible spring is compressed it stores up kinetic energy that is released to assist in lifting the cargo door is moved into a closed position.

### RELATED APPLICATIONS

The present application is based upon and claims priority under 35 U.S.C. §120 to U.S. provisional patent application Ser. No. 60/981,047, filed Oct. 18, 2007, the complete disclosure of which is hereby expressly incorporated herein by reference.

### TECHNICAL FIELD

The present invention relates to vehicles and trailers that carry various types of cargo that is typically loaded and unloaded with the use of a ramp. More particularly, the present invention is directed to a lift assist system for vehicles and trailers that have cargo door that pivot downward and function as loading/unloading ramps.

### BACKGROUND ART

There are numerous vehicles that are used to haul cargo ranging from commercial fleets of trucks, step vans, panel trucks and the like to do-it-yourself rental trucks that consumers can rent to move or haul various items. In addition there are various types of trailers that are used to haul cargo ranging from semi trailers, to trailers that are used to haul recreational vehicles such as snowmobiles, all terrain vehicles (ATV), person watercraft, motorcycles and the like.

In many instances a ramp is used to load and unload cargo from such vehicles and trailers. Removable ramps are common and are either stored within the cargo compartment of the vehicle or trailer and unload for use and loaded after use. Some vehicles provide for ramps that are stored under the cargo compartment. In other instances, the rear or cargo door of the vehicles and trailers can be pivoted downward and used as a ramp; however, it can be difficult, especially in the case of large, heavy cargo doors, for an individual to lift the cargo door back into its closed position.

Lift assist systems have been developed extensively for pickup truck tailgates as exemplified by U.S. Pat. No. 3,336,070 to Jackson, U.S. Pat. No. 4,143,904 to Cooper et al., U.S. Pat. No. 5,358,301 to Konchan et al., U.S. Pat. No. 5,988,724 to Wolda, U.S. Pat. No. 6,637,796 to Westerdale et al., U.S. Pat. No. 6,769,729 to Bruford et al., U.S. Pat. No. 6,793,263 to Bruford et al., U.S. Pat. No. 6,796,592 to Austin, U.S. Pat. No. 6,846,030 to Koehler et al., U.S. Pat. No. 6,874,837 to Bruford et al., and U.S. Pat. No. 6,905,156 to Miller et al. and U.S. Patent Application Publication Nos. 2004/0178651 to Austin and 2005/0194808 to Austin.

Lift assist systems that have been designed and developed for pickup tailgates are generally not suitable or adaptable for used in conjunction with ramps that are used in conjunction with cargo vehicles and trailers. In this regard, pickup truck tailgates are generally hollow which allows for the lift assist systems to be housed therein, dimensionally constrained only by the cavity within the hollow tailgates. In addition, pickup tailgates are relatively short, perhaps being only about two feet tall so there is not much of a moment arm about the axis of pivot of a tailgate. Also, pickup truck tailgates are only pivoted about 90 degrees between a vertical position and a horizontal position (in which they are supported by various linkage brackets).

The present invention provides for lift assist systems for use with door ramps of trucks and trailers which allows the free end of the door ramps of such vehicles and trailers to move assistedly back and forth between a vertical position and an inclined position between which positions the door ramps pivots through a obtuse angle of greater than 90 degrees so that the free end of the door ramp rests on the ground.

### DISCLOSURE OF THE INVENTION

According to various features, characteristics and embodiments of the present invention which will become apparent as the description thereof proceeds, the present invention provides a lift assist system for a cargo door ramp that includes:

a door ramp;

a hinge that pivotally connects the door ramp to a support structure;

at least one spring assembly fixed to the support structure and containing a compressible spring element; and

a cable coupled between the door ramp and spring assembly whereby when the door ramp is pivoted into an open position the cable compresses the spring in the spring assembly and when the door ramp is pivoted into a closed position, kinetic energy stored in the compressed spring assists in closing the door ramp.

The present invention also provides a lift assist system for a pivotal closure that includes:

a pivotal closure;

a hinge that pivotally connects the pivotal closure to a support structure so that the pivotal closure pivots downward into an open position and upward to a closed position;

at least one spring assembly fixed to the support structure and containing a compressible spring element; and

a cable coupled between the pivotal closure and spring assembly whereby when the pivotal closure is pivoted into an open position the cable compresses the spring in the spring assembly and when the pivotal closure is pivoted into a closed position, kinetic energy stored in the compressed spring assists in closing the pivotal closure.

### BRIEF DESCRIPTION OF DRAWINGS

The present invention will be described with reference to the attached drawings which are given as non-limiting examples only, in which:

FIG. 1 a schematic view of the rear of a truck that includes a lift assist system according to one embodiment of the present invention with the door ramp in a closed position.

FIG. 2 a schematic view of the rear of a truck that includes a lift assist system of FIG. 1 with the door ramp in a ramp position.

FIG. 3 a cut away schematic view of the rear of a truck of FIG. 1 with the door ramp in a closed position.

FIG. 4 a cut away schematic view of the rear of a truck of FIG. 2 with the door ramp in a ramp position.

FIG. 5 is a cut away schematic view of the rear of a truck with a door ramp in a closed position according to another embodiment of the present invention.

FIG. 6 is a cut away schematic view of the rear of a truck of FIG. 5 with the door ramp in a ramp position.

FIG. 7 is a top cut away schematic view of the rear of a truck of FIG. 5 with the door ramp in a ramp position.

### BEST MODE FOR CARRYING OUT THE INVENTION

The present invention is directed to lift assist systems for vehicles and trailers that have cargo doors that pivot downward and function as loading/unloading ramps. The term “door ramp” is used herein because the doors of the present invention function both as doors and as ramps. The bottoms of the door ramps are pivotally coupled to a stationary portion of the vehicle or trailer so that their upper or free ends can pivot between a closed position and an inclined position in which the free end can rest on the ground. The door ramps are secured in their closed positions by any suitable latch or catch mechanism. When in their closed positions, the door ramps function as doors to close, cover or seal the rear opening of a cargo compartment of a vehicle or trailer. When in their inclined positions, the door ramps function as inclined ramps along which one can carry, wheel, push, drive or otherwise transfer various types of cargo into and out of the cargo compartment.

Typically the door ramps are solid, non-hollow panels. However, the door ramps can be hollow composite structures so long as they are sturdy or otherwise reinforced sufficiently to support the weight of cargo while it is loaded and unloaded across the door ramps (in their inclined positions). The door ramps can include any suitable handles, straps, etc. required or desired to manually move the door ramps between their closed and inclined positions. It is also within the scope of the present invention to provide an electric or hydraulic mechanism to move the door ramps between their closed and inclined positions.

The lift assist systems of the present invention are mounted between the body, frame or other solid structure of the vehicles or trailers and the door ramps. The lift assist systems include a spring assembly and a pulley system that couples a cable between the spring mechanism and a bracket that is attached to the door ramps. The spring mechanism can be attached to the body, frame or other solid structure of the vehicles or trailers in a position in which it does not interfere with loading or unloading cargo. The bracket is attached to the door ramp at a solid or reinforced portion of the door ramp. The bottom of the door ramp is pivotally coupled to the body, frame or other solid structure of the vehicle or trailer by two or more hinges through which the pivot axis of the door ramp extends. As the door ramp is moved from its closed position to its inclined position, the cable attached to the bracket is pulled through the pulley system so that the opposite end of the cable pulls against a spring element in the spring assembly and compresses the spring element. The resulting force (i.e. kinetic energy) that is built up and stored in the compressed spring is subsequently used to assist in raising the door ramp into its closed position.

The invention will now be described in detail with reference made to the drawings in which common reference numerals have been used to identify similar elements when practical to simplify the description.

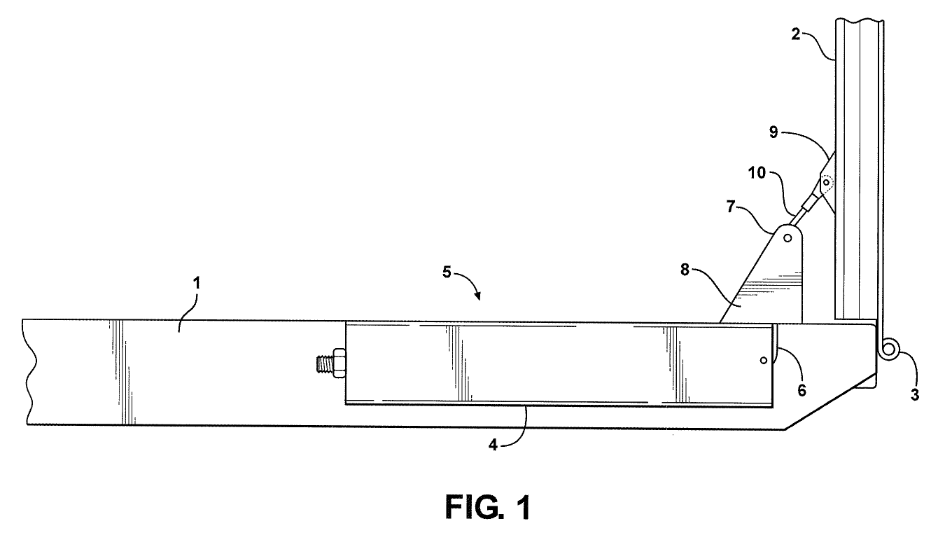

FIG. 1 a schematic view of the rear of a truck that includes a lift assist system according to one embodiment of the present invention with the door ramp in a closed position.

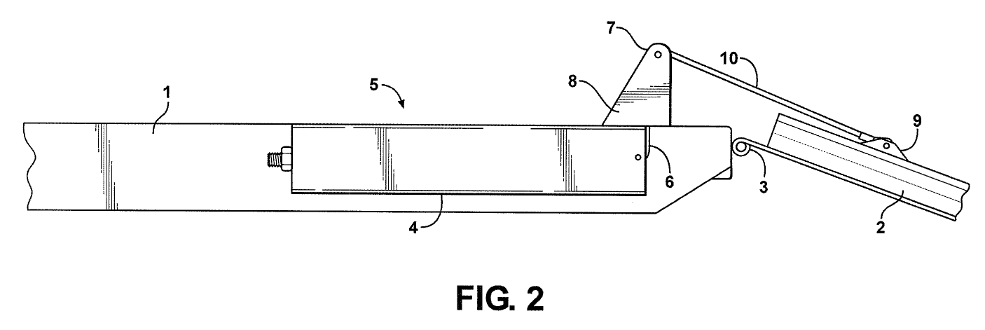

The portion of the truck shown in FIG. 1 includes a frame or chassis 1 to which an axle (not shown) having wheels (not shown) is coupled in a conventional manner. A door ramp 2 is shown in its closed position at the very rear of the truck in FIG. 1. The door ramp 2 extends horizontally between the opposed sides and vertically between the top and bottom of the rear of the truck in a conventional manner. It is noted that a similar door ramp 2 could be provided for a trailer rather than a truck according to the present invention. The door ramp 2 is pivotally coupled to the frame or chassis 1 of the truck by one or more conventional hinges 3 so that the door ramp 2 can pivot between the closed position depicted in FIG. 1 and a ramp position (See FIG. 2) in which the top of the door ramp 2 rests on the ground and the door ramp 2 extends at an inclined angle downward from the frame or chassis 1 at the rear of the truck.

The door ramp 2 can be a solid panel that can be made from any suitably strong material, including wood, metals, composites, laminates, etc. Alternatively, the door ramp 2 can be a hollow structure or hollow composite structure. In either case the door ramp 2 can be reinforced externally or internally to support the weight of cargo while it is loaded and unloaded across the door ramp 2. For example, a support frame can extend at least around the periphery of the door ramp 2. It is to be understood that the door ramp 2 can include any suitable handles, straps, etc. required or desired to manually move the door ramp 2 between its closed and inclined ramp positions.

In FIG. 1 the visible elements of the lift assist system include the housing 4 of the spring assembly 5, the pulley system which includes a pulley 6 on the end of the spring assembly 5, and intermediate pulley 7 mounted on a pulley support 8 a bracket 9 that is fastened to the cargo door 2 and a cable 10 that connects between the spring assembly 5 and bracket 9. It is noted that one end of the cable 10 is pivotally attached to bracket 9 as shown.

In the configuration depicted in FIG. 1 the cargo door 2 is in its closed position and the length of the cable 10 between the spring assembly 5 and bracket 9 is short.

FIG. 2 a schematic view of the rear of a truck that includes a lift assist system of FIG. 1 with the door ramp in a ramp position. When the door ramp 2 is opened as shown in FIG. 2 the normally top portion of the door rests on the ground so that the door ramp 2 is inclined as depicted. As the door ramp 2 pivots downward about hinge(s) 3 cable 10 is pulled so that the length of the cable 10 between the spring assembly 5 and bracket 9 is extended as shown. Also the end of cable 10 that is attached to bracket 9 pivots with respect to bracket 9 as can be seen by comparing FIGS. 1 and 2.

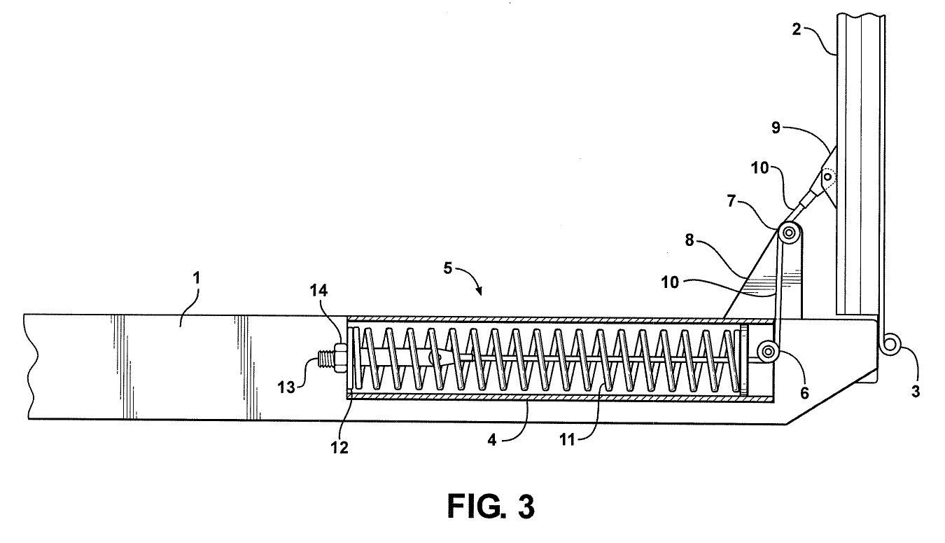

FIG. 3 a cut away schematic view of the rear of a truck of FIG. 1 with the door ramp in a closed position. As shown in FIG. 3, the housing 4 of the spring assembly 5 houses a spring element 11. One end of the spring element 11 rests against an end of the housing 4. The opposite end of the spring element 11 is caught or secured to a plate 12 that is coupled to an end of cable 10. As cable 10 is pulled (when the door ramp 2 is lowered), the end of the cable that is coupled to plate 12 pulls plate 12 against spring element 11 so as to compress spring element 11 within housing 4.

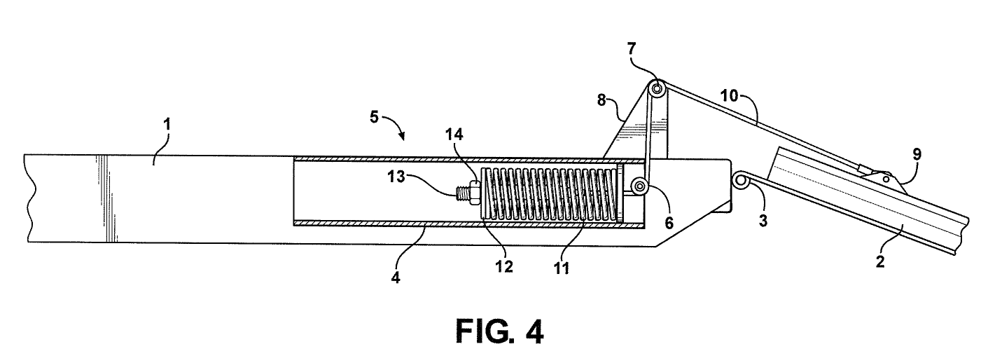

FIG. 4 a cut away schematic view of the rear of a truck of FIG. 2 with the door ramp in a ramp position. As shown in FIG. 4, when the door ramp 2 is opened and in the ramp position, spring element 11 is compressed by the pulling force applied thereto by plate 12 which in turn is pulled by cable 10. As a result, force is generated and stored up in spring element 11. This forced that is generated and stored up in spring element 11 can be released and used to assist in lifting the door ramp 2 to its closed position. Further, as the door ramp 2 is pivoted into the open position, the force generated and stored up in spring element 11 helps stabilize the door ramp by effectively reducing the weight thereof while supporting the weight.

As show in FIGS. 3 and 4, the end of cable 10 in housing 4 is coupled to plate 12 by a mechanism that allows for adjustment of the force of the spring applied to and created by cable 10. In this regard, the embodiment shown includes a threaded member 13 that is attached the end of cable 10 and extends through a hole in plate 12. A complementary threaded member 14, e.g. a nut is threadedly coupled to threaded member 13 on the opposite side of plate 12. In this configuration the position of the complementary threaded member 14 can be adjusted along threaded member 13 so as to adjust the force of the spring element 11 applied to and created by cable 10. Plate 12 needs to be configured or fixed with respect to housing 4 so that plate 12 will not rotate with threaded member 14. In one embodiment housing 4 and plate 12 are made so that they have square cross-sectional shapes.

The housing 4 can have a generally cylindrical shape or a shape that has a circular or non-circular area with either or both ends being closed or covered with removable covers to prevent dirt and debris from entering the spring assembly 5. Whereas one spring element 11 is shown in the figures, it is to be understood that more than on spring element can be provided in housing 4. The pulley system shown includes a pulley 6 attached to an end of housing 4 and a pulley 7 attached to pulley support 8. Pulley support 8 is mounted to a portion of the truck (or trailer) such as the bed or floor of a cargo area or the body, frame, chassis or other solid structure associated with the truck (or trailer). It is to be understood that the spring assembly 5 can be located at any convenient location on, in or under a truck (or trailer) and that the pulley system can include any number of pulleys and pulley supports as desired to couple the cable 10 to bracket 9 and the spring assembly 5. It is also within the scope of the present invention to pivotally couple one end of the spring assembly 5 to the truck (or trailer).

According to one embodiment, a spring assembly 5 is provided on either side of a truck or trailer and a bracket 9 is provide on either side of the door ramp 2 in a location that minimizes interference with loading and unloading cargo. It is also possible to provide one spring assembly 5 that can be located centrally or in some other suitable position and a dual cable system that connects to two brackets 9 provided on opposite sides of the door ramp 2. Other configurations that include one, two or more spring assemblies could also be used according to the present invention.

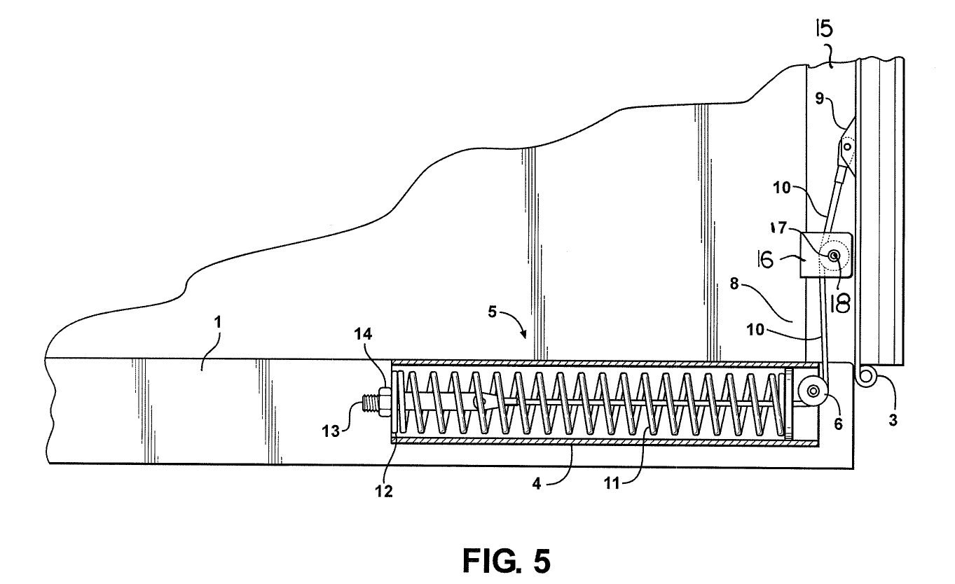

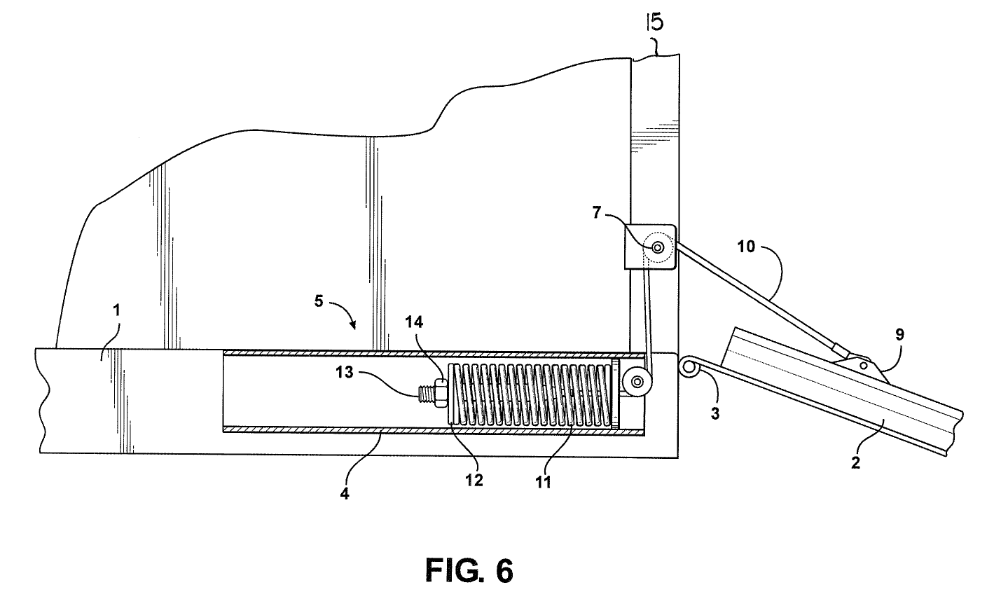

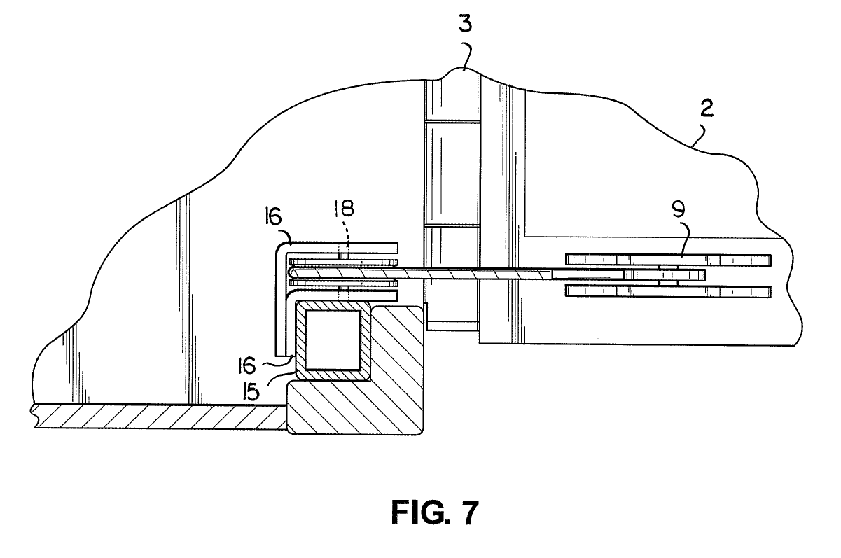

FIG. 5 is a cut away schematic view of the rear of a truck with a door ramp in a closed position according to another embodiment of the present invention. FIG. 6 is a cut away schematic view of the rear of a truck of FIG. 5 with the door ramp in a ramp position. FIG. 7 is a top cut away schematic view of the rear of a truck of FIG. 5 with the door ramp in a ramp position.

In the embodiment of the invention shown in FIGS. 5-7 the pulley supports 8 are mounted on vertical door frame members 15 in accordance with the discussion above that the pulley supports 8 can be mounted to any other solid structure associated with the truck (or trailer).

The pulley supports 8 in FIGS. 5-7 include two brackets or plates 16, one of which is attached to a vertical frame member 15, by welding or other suitable means. A pulley 17 is provided between the two brackets or plates 16 on a pin or rod 18 about which the pulley 17 is free to rotate. The pulley supports 8 and brackets 9 in all the embodiments are configured and aligned so that the cable 10 can freely move without binding. For example, the pulley supports 8 in the embodiment of the invention shown in FIGS. 5-7 position the pulleys 17 slightly inward from the vertical frame members 15 so that the pulleys 17 are substantially aligned with brackets 9. Also as can be understood from all the figures, the pulley supports 8 are configured and positioned so that there is a clearance between the pulley supports 8 and the brackets 9 when the door ramps 2 are in their closed positions.

In the embodiment of the invention shown in FIGS. 5-7, pulleys 6 can also be mounted to a lower portion of the vertical frame members 15 or any sturdy structure such as the chassis or frame of the truck (or trailer).

During the course of the present invention it was determined that for heavy doors, friction within the hinge(s) 3, particularly adjacent the ends wherein the cables 10 pull between the pulleys 17 and door ramps 2, could add resistance to lifting the door ramps 2. This friction can be reduced by including bearings within at least the ends of the hinges 3. Such bearings could be made of any suitable bearing material such as brass or other known metallic bearing material or polymer material.

It was also determined that although roller bearings were suitable for use with the pulleys, using pin or needle bearings significantly reduced friction in the pulleys.

It is to be understood that the configuration of the overall lift assist system of the present invention, including the placement and alignment and number of the various elements, including the pulleys, pulley supports, brackets, and spring housing can be varied from the non-limiting examples provided in the figures. The position of the pulley support(s) can be adjusted as desired to change the forces acting on the cable(s) and spring elements. Likewise the position of the brackets 9 can be adjusted as desired to change the forces acting on the cable(s) and spring elements.

Although one spring element 11 is shown in the housing 4, it is possible according to the present invention to include more than on spring element 11 within housing 4 in a stacked manner. It is also possible according to the present invention to use a bank of spring elements in a common or separate housing which would allow for installation in tighter space restrictions.

It is noted that while reference is generally made to a truck in FIGS. 1-7, as discussed above, the lift assist system of the present invention can also be incorporated into a trailer, or even a non-mobile or stationary storage container or structure having a door or end or side that opens by pivoting downwardly.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A lift assist system for a cargo door ramp that comprises:
a door ramp;
a hinge that pivotally connects the door ramp to a support structure;
at least one spring assembly fixed to the support structure and containing a compressible spring element; and
a cable coupled between the door ramp and spring assembly whereby when the door ramp is pivoted into an open position the cable compresses the spring in the spring assembly and when the door ramp is pivoted into a closed position, kinetic energy stored in the compressed spring assists in closing the door ramp.

2. A lift assist system for a cargo door ramp according to claim 1, further comprising a pulley system through which the cable is coupled between the door ramp and spring assembly.

3. A lift assist system for a cargo door ramp according to claim 1, wherein the pulley system comprises two or more pulleys.

4. A lift assist system for a cargo door ramp according to claim 1, wherein the at least one spring assembly is provided at or vertically below the hinge.

5. A lift assist system for a cargo door ramp according to claim 1, wherein the spring assembly comprises a housing that houses the compressible spring element.

6. A lift assist system for a cargo door ramp according to claim 1, wherein the door ramp comprises a vehicle door.

7. A lift assist system for a cargo door ramp according to claim 1, wherein the door ramp comprises a trailer door.

8. A lift assist system for a cargo door ramp according to claim 1, wherein the support structure comprises a body, frame or chassis of a vehicle.

9. A lift assist system for a cargo door ramp according to claim 8, wherein the vehicle comprises a motorized vehicle.

10. A lift assist system for a cargo door ramp according to claim 1, wherein the at least one spring assembly is fixed below the support structure.

11. A lift assist system for a cargo door ramp according to claim 2, wherein the pulley system includes a pulley support that is mounted to a horizontal structure of the support structure.

12. A lift assist system for a cargo door ramp according to claim 2, wherein the pulley system includes a pulley support that is mounted to a vertical structure that is coupled to the support structure.

13. A lift assist system for a pivotal closure that comprises:
a pivotal closure;
a hinge that pivotally connects the pivotal closure to a support structure so that the pivotal closure pivots downward into an open position and upward to a closed position;
at least one spring assembly fixed to the support structure and containing a compressible spring element; and
a cable coupled between the pivotal closure and spring assembly whereby when the pivotal closure is pivoted into an open position the cable compresses the spring in the spring assembly and when the pivotal closure is pivoted into a closed position, kinetic energy stored in the compressed spring assists in closing the pivotal closure.

14. A lift assist system for a pivotal closure according to claim 13, further comprising a pulley system through which the cable is coupled between the pivotal closure and spring assembly.

15. A lift assist system for a pivotal closure according to claim 13, wherein the pulley system comprises two or more pulleys.

16. A lift assist system for a pivotal closure according to claim 13, wherein the spring assembly comprises a housing that houses the compressible spring element.

17. A lift assist system for a pivotal closure according to claim 13, wherein the support structure comprises a portion of a vehicle.

18. A lift assist system for a pivotal closure according to claim 13, wherein support structure comprises a portion of a trailer.

19. A lift assist system for a pivotal closure according to claim 17, wherein support structure comprises a body, frame or chassis of a vehicle.

20. A lift assist system for a pivotal closure according to claim 13, wherein support structure comprises a portion of a non-mobile assembly.
